(19) United States
(12) Patent Application Publication
(10) Pub. No.: US 2004/0264196 A1
(43) Pub. Date: Dec. 30, 2004

(54) LED spotlight (type I)

(76) Inventor: Kuo-Fen Shu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/607,990

(22) Filed: Jun. 30, 2003

(51) Int. Cl. F21V 29/00; F21V 17/00

(52) U.S. Cl. 362/294; 362/373; 362/375

(57) ABSTRACT

The present invention relates to a LED spotlight (type I), which includes a lampshell and a light-collecting cover, wherein the cover has its bottom provided with an aperture to engage with a LED. The light-collecting cover is capable of reflecting and concentrating the light emitted from the LED to a same direction that provides an efficient spotlight.

### BACKGROUND OF THE INVENTION

A conventional spotlight mainly includes a shell, a tungsten bulb provided therein, and a glass cover. By use of lighting of the tungsten bulb and reflection from inner curved face of the shell, the most light can be emitted forward concentratively. The known spotlight has following drawbacks:

1. The tungsten bulb has a large volume and occupies large space in the shell. It reduces the reflective effect of lighting.

2. The tungsten bulb needs large power and leads high heat. It will be more possible to cause a fire in accident.

3. It is necessary to use an extra transformer to light the tungsten bulb.

4. The tungsten is easily broken and has a short used period.

Accordingly, the present invention is to overcome the drawback of the conventional product and to provide a LED spotlight, which uses LED and a light-collecting cover to emit light concentratively, and it can be used for a long term and low power needed.

### BRIEF DESCRIPTION OF THE DRAWINGS

The following drawings indicate the character and improvement of the present invention.

FIG. 1 shows an exploded perspective view of a LED spotlight according to the present invention.

FIG. 2 shows an assembled perspective view of FIG. 1.

FIG. 3 shows a cross-sectional plan view of FIG. 2.

### DETAILED DESCRIPTION OF THE INVENTION

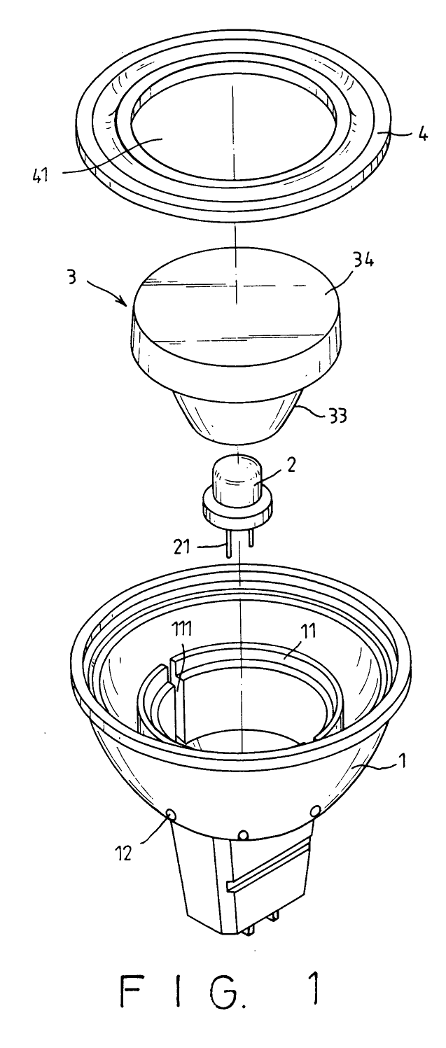

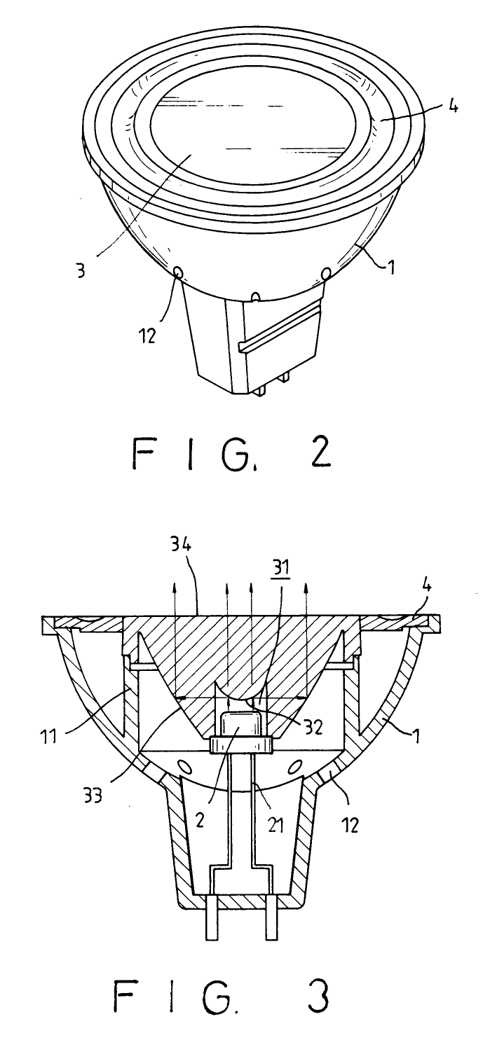

Please referring to FIG. 1 to 3, the present invention relates to an improvement of a spotlight, which includes a lampshell (1), a LED (2), a light-collecting cover (3), and a cap (4). The lampshell (1) can be provided with a connecting ring (11) having several gaps (111) to provide an elastic force for engaging with the light-collecting cover (3). Several vents (12) can be formed on the lampshell (1). The light-collecting cover is a transparent solid body and has its side being a paraboloid (33). An aperture (31) is formed at bottom side of the cover (3) while a convex (32) is formed therein. A plane (34) is on top of the cover (3). The LED (2) can be connected within the aperture (31) while two conductive rods (21) are extended downward to connect with conductive joint outside the lampshell (1). The cap (4) is assembled on the lampshell (1) and the top of the light-collecting cover (3) is engaged within central hole (41) of the cap (4).

In use, when the LED (2) is lighting, the light can be emitted concentratively forward in the arrow direction as shown in FIG. 3, because of the light-collecting cover (3) and its side paraboloid (33) to reflecting the light efficiently. Hence, the LED spotlight obtains a perfect light effect.

Since the LED will not cause high heat and has a long used period, the use of the present invention will be secure and utilized. It can be lightened by a low voltage and AC current directly. Moreover, the light-collecting cover can provide a well effect for concentrating the light and reaches an excellent spotlight.

What is claimed is:

1. A LED spotlight (type I) including a lampshell and a light-collecting cover, wherein the cover has its bottom provided with an aperture to engage with a LED, in which a convex being formed in the aperture and the side of the cover being a paraboloid; the light-collecting cover being capable of reflecting and concentrating the light emitted from the LED to a same direction.

2. A LED spotlight (type I) as claimed in claim 1, wherein a connecting ring is provided in the lampshell to elastically engage with the light-collecting cover.

3. A LED spotlight (type I) as claimed in claim 1, wherein a cap is assembled on the lampshell to hold the top of the cover.

4. A LED spotlight (type I) as claimed in claim 1, wherein the lampshell is provided with several vents.
